(19) United States
(12) Patent Application Publication
(10) Pub. No.: US 2004/0107338 A1
(43) Pub. Date: Jun. 3, 2004

(54) Facility for detecting coupling of interface card

(76) Inventor: Jesse Kao, Hsin Chuang City (TW)

Correspondence Address: Jesse Kao, P.O. Box 4-67, Hsin Chuang, Taipei, 242, TW

(21) Appl. No.: 10/313,429

(22) Filed: Dec. 3, 2002

(51) Int. Cl. G06F 15/177

(52) U.S. Cl. 713/2

(57) ABSTRACT

A connecting and detecting facility includes a connecting device coupled between a CPU and an interface card, and having a rebooting device for rebooting the CPU when the interface card is coupled to and disconnected from the CPU. The rebooting device includes a detecting device coupled between the CPU and the interface card to detect either a coupling or a disconnecting of the interface card from the CPU. A processing device is coupled between the detecting device and the CPU, and includes a transistor coupled to an inverter and to reboot the CPU via the inverter.

### BACKGROUND OF THE INVENTION

1. Field of the Invention

The present invention relates to a connecting and detecting facility, and more particularly to a connecting and detecting facility for being coupled between interface card and central processing unit (CPU), and for detecting the coupling of the interface card to the CPU.

2. Description of the Prior Art

For typical computer facilities, when it is required to couple various interface cards to the central processing unit (CPU) of the computer facilities, the computer should be switched or turned off, and should be re-energized again, for allowing the interface cards to be safely connected to and to be rebooted by the CPU. Particularly, when the computer is still energized and worked, and when the interface cards are unplugged or disengaged from or hot-swapping from the computer, various kinds of “error” state information may be generated, and the computer may become fail, and such that the computer should be switched or turned off and then should be re-energized again and again. It will thus be taken much time to couple to and to disengage the peripheral facilities from the computer frequently, in order to test whether the peripheral facilities may be coupled to the computer or not.

The present invention has arisen to mitigate and/or obviate the afore-described disadvantages of the conventional computer facilities.

### SUMMARY OF THE INVENTION

The primary objective of the present invention is to provide a connecting and detecting facility for being coupled between the interface card and the CPU of a computer facility, and for detecting the coupling of the interface card to the CPU of the computer facility and for rebooting the computer without switching off or turning off the computer.

In accordance with one aspect of the invention, there is provided a connecting and detecting facility comprising a central processing unit (CPU), an interface card, and a connecting device coupled between the CPU and the interface card, and the connecting device including a rebooting device for rebooting the CPU when the interface card is coupled to and disconnected from the CPU.

The rebooting device includes a detecting device coupled between the CPU and the interface card to detect a coupling of the interface card to the CPU, and includes a processing device coupled between the detecting device and the CPU.

The processing device includes an inverter coupled to the CPU, a transistor including an emitter coupled to a power source, a collector coupled to the inverter, and a base coupled to the interface card via the detecting device and to receive an actuating signal from the detecting device, the inverter converts the actuating signal to a rebooting signal which is then sent to the CPU.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram of a connecting and detecting facility in accordance with the present invention;

FIG. 2 is a schematic view showing an electric circuit of the connecting and detecting facility;

FIG. 3 is a schematic view similar to FIG. 2, illustrating the actuation of the electric circuit when plugging or connecting the interface card; and

FIG. 4 is a schematic view similar to FIGS. 2, and 3, illustrating the actuation of the electric circuit when unplugging or disconnecting the interface card from the computer.

### DETAILED DESCRIPTION OF THE PREFERRED EMBODIMENT

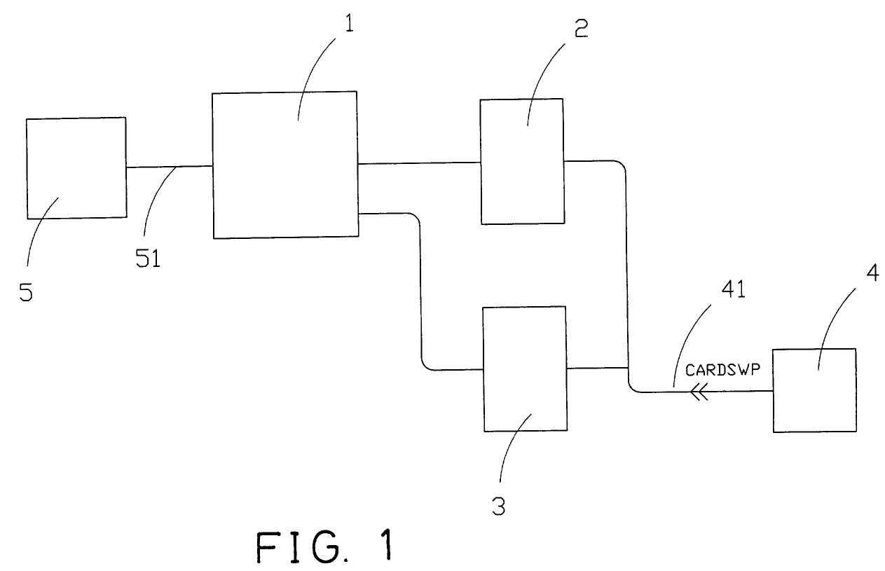

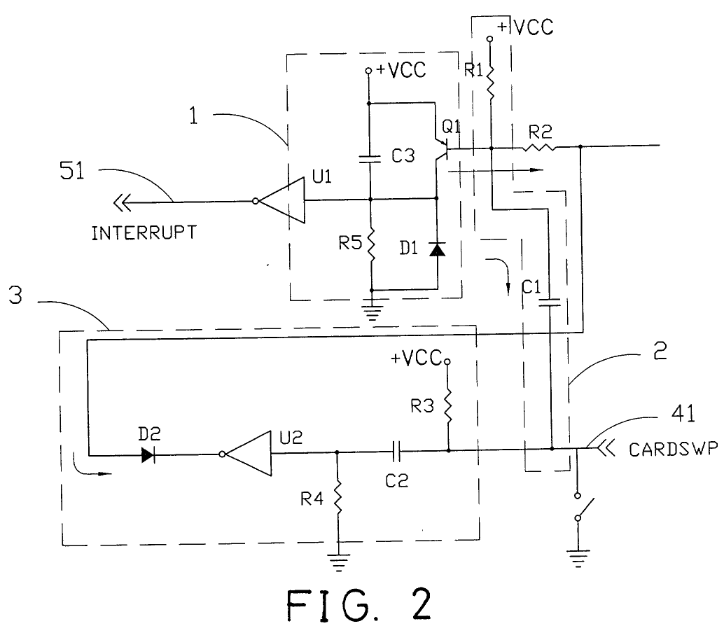

Referring to the drawings, and initially to FIGS. 1 and 2, a connecting and detecting facility in accordance with the present invention comprises a signal processing device 1 coupled to a terminal 51 of a central processing unit (CPU) 5 of a computer, two detecting devices 2, 3, coupled to the processing device 1, and coupled to a terminal 41 of an interface card 4.

As best shown in FIG. 2, the signal processing device 1 includes a transistor Q1 having an emitter coupled to the power source Vcc, a collector coupled to the terminal 51 of the CPU 5 via an inverter U1, in which the inverter U1 is coupled to the power source Vcc via a capacitor C3 and is grounded via a resistor R5. The collector of the transistor Q1 is grounded via a diode D1, for preventing electricity from flowing backwardly toward the collector of the transistor Q1.

In operation, when a signal, such as a positive voltage greater than a predetermined initializing value, is applied to the base of the transistor Q1, the emitter and the collector of the transistor Q1 may be electrically connected together, in order to actuate the CPU 5 to reboot the interface card 4. The details of how the CPU 5 to reboot the interface card 4 will be discussed hereinafter.

The detecting device 2 includes a resistor R1 and a capacitor C1 coupled together in series, and the resistor R1 is coupled to the power source Vcc, and the capacitor C1 is coupled to the terminal 41 of the interface card 4. The collector of the transistor Q1 is coupled between the resistor R1 and the capacitor C1. The detecting device 2 is provided for detecting whether the interface card 4 is plugging to the computer or not, and/or to reboot the CPU 5 when the interface card 4 is plugged or coupled to the computer.

The other detecting device 3 includes a resistor R3 and a capacitor C2 coupled to an inverter U2, which is then coupled to the collector of the transistor Q1 via a diode D2 and a resistor R2. The resistor R3 is coupled to the power source Vcc. A further resistor R4 has one end coupled between the capacitor C2 and the inverter U2, and the other end grounded. The detecting device 3 is provided for detecting whether the interface card 4 is unplugging or disengaging from the computer or not, and/or to reboot the CPU 5 when the interface card 4 is unplugged or disengaged or disconnected from the computer.

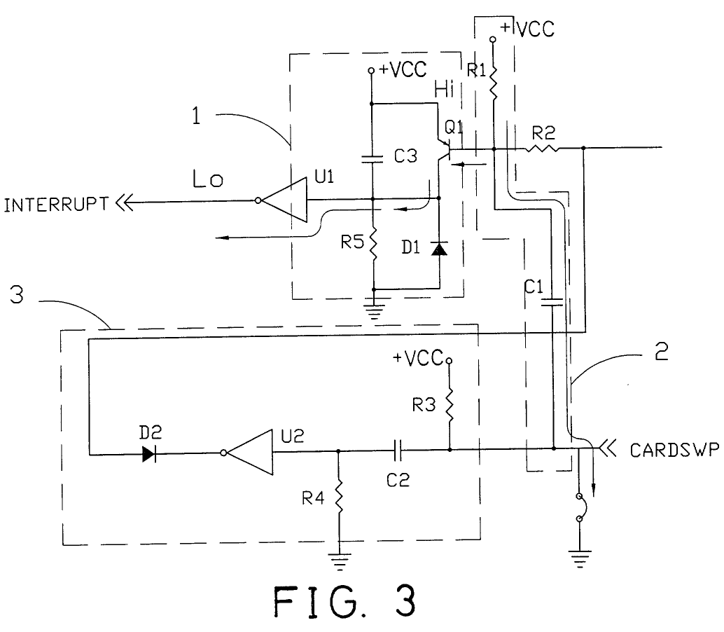

In operation, as shown in FIG. 3, when the interface card 4 is plugging to the computer, the terminal 41 of the interface card 4 will be grounded in order to form a close circuit. After a period of time, or after a time of a pulse, the capacitor C1 will apply a high potential positive voltage or actuating signal to the transistor Q1, and then to the inverter U1 via the collector of the transistor Q1, and then the high potential positive voltage or signal will be converted to a low potential positive voltage or rebooting signal by the inverter U1.

The low potential positive voltage or rebooting signal through the inverter U1 will then be sent to the terminal 51 of the CPU 5, and the CPU 5 will then be actuated or energized or rebooted by the low potential positive voltage or rebooting signal, in order to fetch the information, such as the driving signal from the interface card 4.

At this moment, due to the grounding or the closing of the circuit by the plugging of the interface card 4, the resistor R1 and the capacitor C1 of the first detecting device 2 form a close circuit for allowing electrically to flow through the resistor R1 and the capacitor C1, such that no electricity will flow through the second detecting device 3 at this moment, and such that the second detecting device 3 will not be energized or actuated or operated.

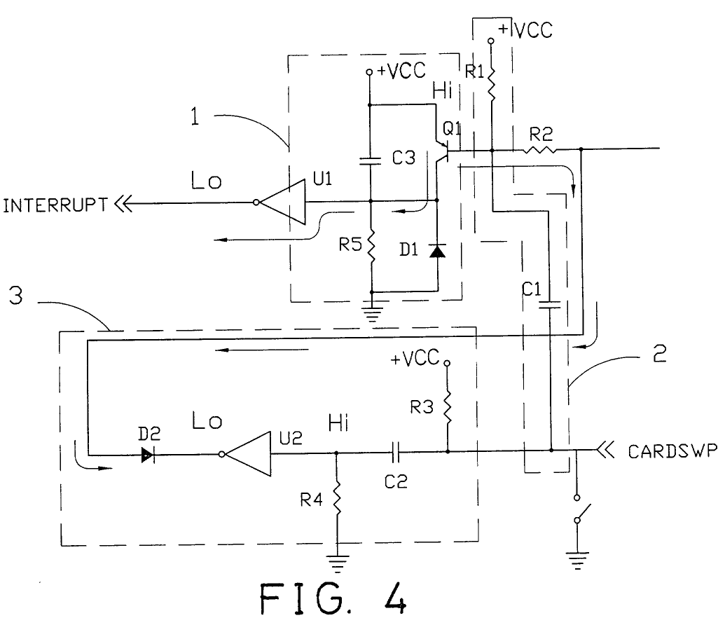

As shown in FIG. 4, when the interface card 4 is unplugged from the computer, the terminal 41 of the interface card 4 or the electric circuit through the terminal 41 of the interface card 4 will be opened. The resistors R3, R4 and the capacitor C2 of the second detecting device 3 will then be energized by the electric power source Vcc in order to form or generate and send a high potential positive voltage or signal to the inverter U2. The high potential positive voltage or signal then will also be converted to a low potential positive voltage or rebooting signal by the inverter U2.

At this moment, the electricity from the power source Vcc may flow through the emitter and the base of the transistor Q1, the resistor R2, and through the diode D2, and then into the inverter U2. The collector of the transistor Q1 will also be actuated, or electricity or high voltage actuating signal from the power source Vcc will also flow from the collector of the transistor Q1 to the inverter U1, and will then be converted by the inverter U1 to the low potential positive voltage or rebooting signal.

The low potential positive voltage or rebooting signal through the inverter U1 will then be sent to the terminal 51 of the CPU 5, and the CPU 5 will then be actuated or rebooted by the low potential positive voltage or rebooting signal. The information that was previously stored or memorized in the CPU 5 from the interface card 4 may also be fetched by or sent to the CPU 5. At this moment, due to or after the unplugging of the interface card 4, the first detecting device 2 will be off and need not further detect whether the interface card 4 is plugging to the computer or not.

Accordingly, the computer or the CPU 5 may be reboot at any time when the interface card 4 is plugged to the computer or unplugged from the computer, without switching off the computer. For example, when the interface card 4 is plugged to the computer, the first detecting device 2 will be energized, and may actuate the collector of the transistor Q1 to actuate or to reboot the CPU 5 via the inverter U1. When the interface card 4 is unplugged from the computer, the second detecting device 3 will be energized, and may also actuate the collector of the transistor Q1 to actuate or to reboot the CPU 5 via the inverter U1.

Accordingly, the connecting and detecting facility in accordance with the present invention may be used for detecting the coupling of the interface card to the CPU of the computer facility and for rebooting the computer either when the interface card is plugged to or unplugged from the computer, without switching off or turning off the computer.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A connecting and detecting facility comprising:
a central processing unit (CPU),
an interface card, and
a connecting device coupled between said CPU and said interface card, and said connecting device including means for rebooting said CPU when said interface card is coupled to and disconnected from said CPU.

2. The detecting facility according to claim 1, wherein said rebooting means includes a detecting device coupled between said CPU and said interface card to detect a coupling of said interface card to said CPU.

3. The detecting facility according to claim 2, wherein said rebooting means further includes a processing device coupled between said detecting device and said CPU.

4. The detecting facility according to claim 3, wherein said processing device includes an inverter coupled to said CPU, a transistor including an emitter coupled to a power source, a collector coupled to said inverter, and a base coupled to said interface card via said detecting device and to receive an actuating signal from said detecting device, said inverter converts said actuating signal to a rebooting signal which is then sent to said CPU.

5. The detecting facility according to claim 1, wherein said rebooting means includes a detecting device coupled between said CPU and said interface card to detect a disconnecting of said interface card from said CPU.

6. The detecting facility according to claim 5, wherein said rebooting means further includes a processing device coupled between said detecting device and said CPU.

7. The detecting facility according to claim 6, wherein said processing device includes an inverter coupled to said CPU, a transistor including an emitter coupled to a power source, a collector coupled to said inverter, and a base coupled to said interface card via said detecting device and to receive an actuating signal from said detecting device, said inverter converts said actuating signal to a rebooting signal which is then sent to said CPU.
